(19) United States
(12) Patent Application Publication
(10) Pub. No.: US 2025/0261154 A1
(43) Pub. Date: Aug. 14, 2025

(54) MULTIPLE SELECTION WINDOWS FOR A SIDELINK RESOURCE POOL FOR POSITIONING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/855,263

(22) PCT Filed: Feb. 23, 2023
(86) PCT No.: PCT/US2023/063100

§ 371 Date: Oct. 8, 2024

(30) Foreign Application Priority Data
May 12, 2022 (GR) 20220100390

(51) Int. Cl. H04W 64/00; G01S 5/02; H04L 5/00; H04W 72/25

(52) U.S. Cl. CPC H04W 64/00; G01S 5/0205; H04L 5/0051; H04W 72/25

(57) ABSTRACT

Disclosed are techniques for wireless positioning. In an aspect, a user equipment (UE) may receive, from a configuration entity, such as an anchor UE, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS). The UE may perform SL positioning using one of the plurality of selection windows for SL positioning. This may include identifying, during a sensing window, candidate resources within the RPP, determining that a SL-PRS should be transmitted or received, identifying a selection window from among the plurality of selection windows, selecting, from among resources within the first selection window, one or more resources for transmitting or receiving an SL-PRS, and transmitting or receiving the SL-PRS on the selected resource(s).

### CROSS-REFERENCE TO RELATED APPLICATIONS

The present Application for Patent claims priority to Greek Patent Application No. 20220100390, entitled “MULTIPLE SELECTION WINDOWS FOR A SIDELINK RESOURCE POOL FOR POSITIONING,” filed May 12, 2022, and is a national stage application, filed under 35 U.S.C. § 371, of International Patent Application No. PCT/US2023/063100, entitled “MULTIPLE SELECTION WINDOWS FOR A SIDELINK RESOURCE POOL FOR POSITIONING,” filed Feb. 23, 2023, both of which are assigned to the assignee hereof and expressly incorporated herein by reference in their entirety.

### BACKGROUND OF THE DISCLOSURE

### 1. Field of the Disclosure

Aspects of the disclosure relate generally to wireless positioning.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless positioning performed by a user equipment (UE) includes receiving, from a configuration entity, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS); and performing SL positioning using one of the plurality of selection windows for SL positioning.

In an aspect, a method of wireless positioning performed by a configuration entity includes identifying a UE; and sending, to the UE, a first configuration, the first configuration defining a plurality of selection windows for SL positioning, each selection window defining a set of resources within a RPP for transmission or reception of at least one SL-PRS.

In an aspect, a UE includes a memory; at least one transceiver; and at least one processor communicatively coupled to the memory and the at least one transceiver, the at least one processor configured to: receive, from a configuration entity via the at least one transceiver, a first configuration, the first configuration defining a plurality of selection windows for SL positioning, each selection window defining a set of resources within a RPP for transmission or reception of at least one SL-PRS; and perform, using the at least one transceiver, SL positioning using one of the plurality of selection windows for SL positioning.

In an aspect, a configuration entity includes a memory; at least one transceiver; and at least one processor communicatively coupled to the memory and the at least one transceiver, the at least one processor configured to: identify a UE; and send, to the UE via the at least one transceiver, a first configuration, the first configuration defining a plurality of selection windows for SL positioning, each selection window defining a set of resources within a RPP for transmission or reception of at least one SL-PRS.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates an example of a wireless communications system that supports unicast sidelink establishment, according to aspects of the disclosure.

FIG. 5 illustrates a resource pool, according to aspects of the disclosure.

FIG. 6 illustrates a resource pool used for sidelink communications (SL-RP), according to aspects of the disclosure.

FIG. 7 illustrates a resource pool for sidelink positioning (SL-RPP), according to aspects of the disclosure.

FIG. 8 illustrates a method for coordinated reservation of SL-RPPs according to aspects of the disclosure.

FIG. 9 illustrates a process for autonomous selection of subframes for SL data transmissions, according to aspects of the disclosure.

FIG. 10 illustrates a segmented selection window for SL data transmission, according to aspects of the disclosure.

FIG. 11 illustrates another example of multiple selection windows for an SL-RPP, according to aspects of the disclosure.

FIG. 12 illustrates another example of multiple selection windows for an SL-RPP, according to aspects of the disclosure.

FIG. 13 illustrates another example of multiple selection windows for an SL-RPP, according to aspects of the disclosure.

FIG. 14 illustrates another example of multiple selection windows for an SL-RPP, according to aspects of the disclosure.

FIG. 15 is a flowchart of an example process, performed by a UE, associated with multiple selection windows for a sidelink resource pool for positioning, according to aspects of the disclosure.

FIG. 16 is a flowchart of an example process, performed by a configuration entity, associated with multiple selection windows for a sidelink resource pool for positioning, according to aspects of the disclosure.

### DETAILED DESCRIPTION

Disclosed are techniques for wireless positioning. In an aspect, a user equipment (UE) may receive, from a configuration entity, such as an anchor UE, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS). The UE may perform SL positioning using one of the plurality of selection windows for SL positioning. This may include identifying, during a sensing window, candidate resources within the RPP, determining that a SL-PRS should be transmitted or received, identifying a selection window from among the plurality of selection windows, selecting, from among resources within the first selection window, one or more resources for transmitting or receiving an SL-PRS, and transmitting or receiving the SL-PRS on the selected resource(s).

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

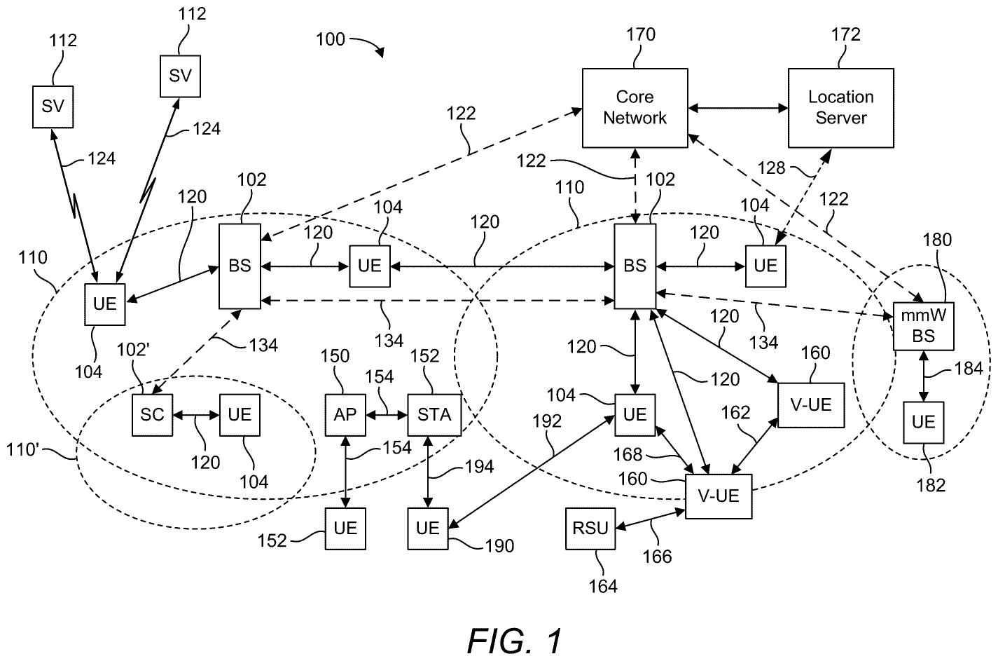

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen-before-talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11 p, for V2V, V2I, and V2P communications. IEEE 802.11 p is an approved amendment to the IEEE 802.11 standard and operates in the licensed ITS band of 5.9 GHz (5.85-5.925 GHz) in the U.S. In Europe, IEEE 802.11 p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. As another example, the D2D P2P links 192 and 194 may be sidelinks, as described above with reference to sidelinks 162, 166, and 168.

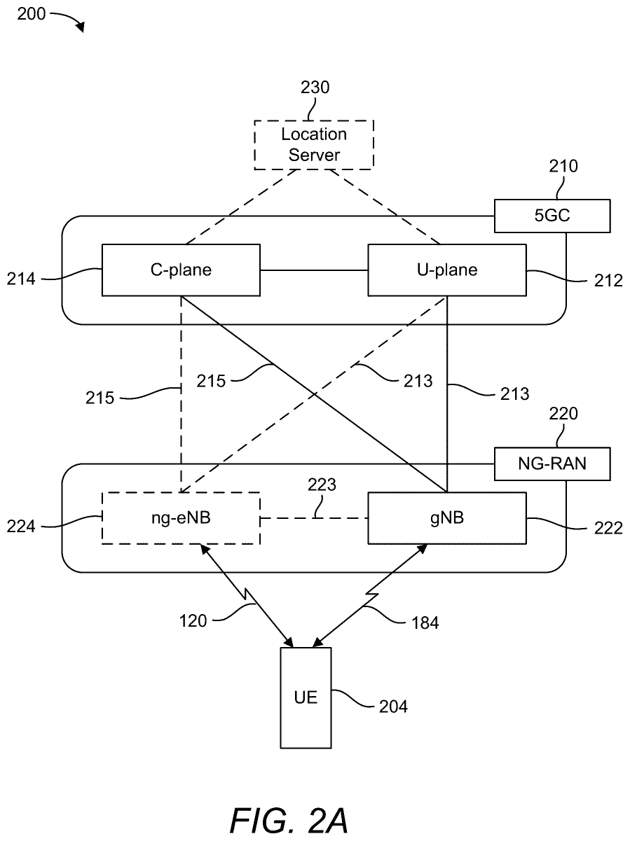

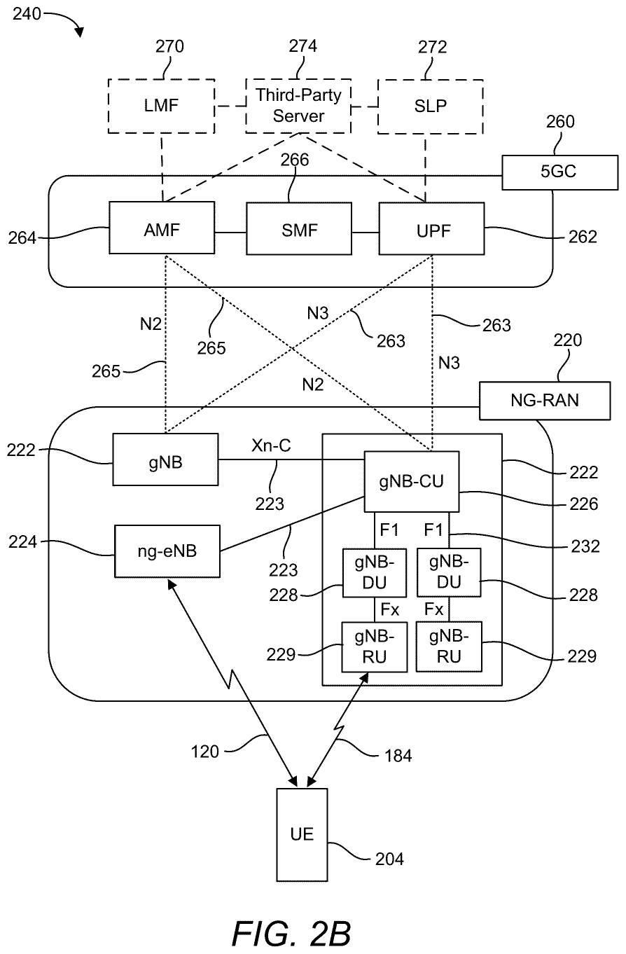

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUS 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit—User Plane (CU-UP)), control plane functionality (i.e., Central Unit—Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

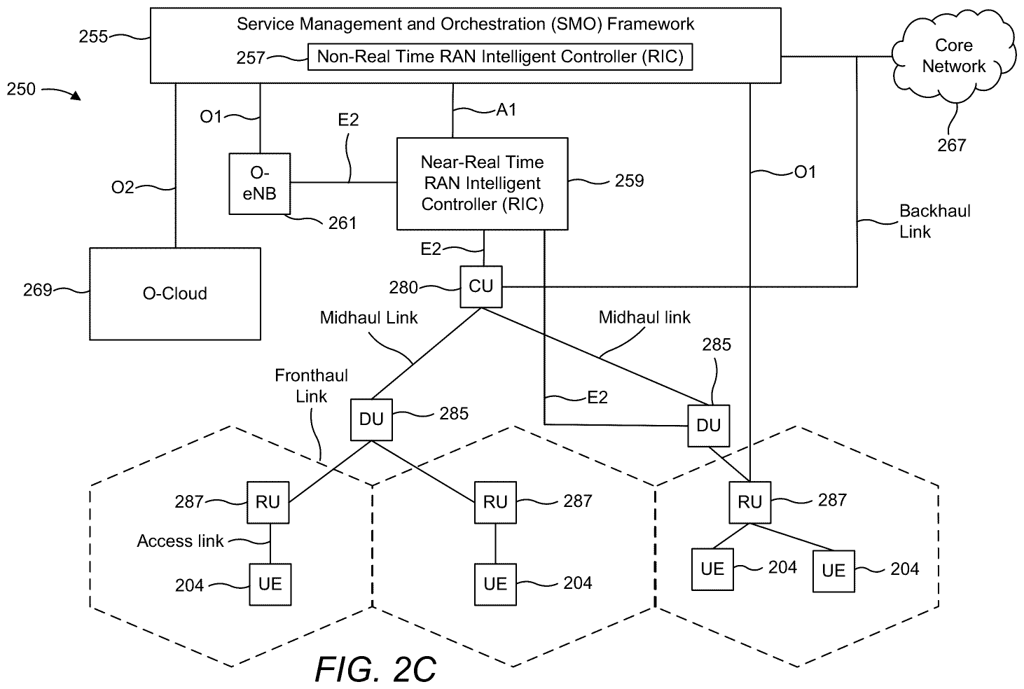

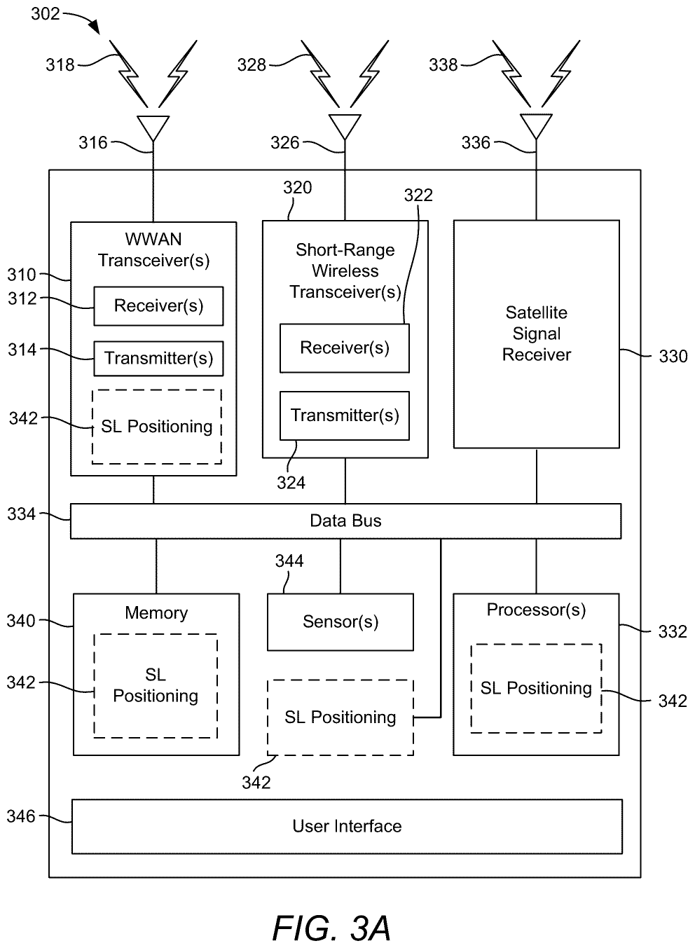

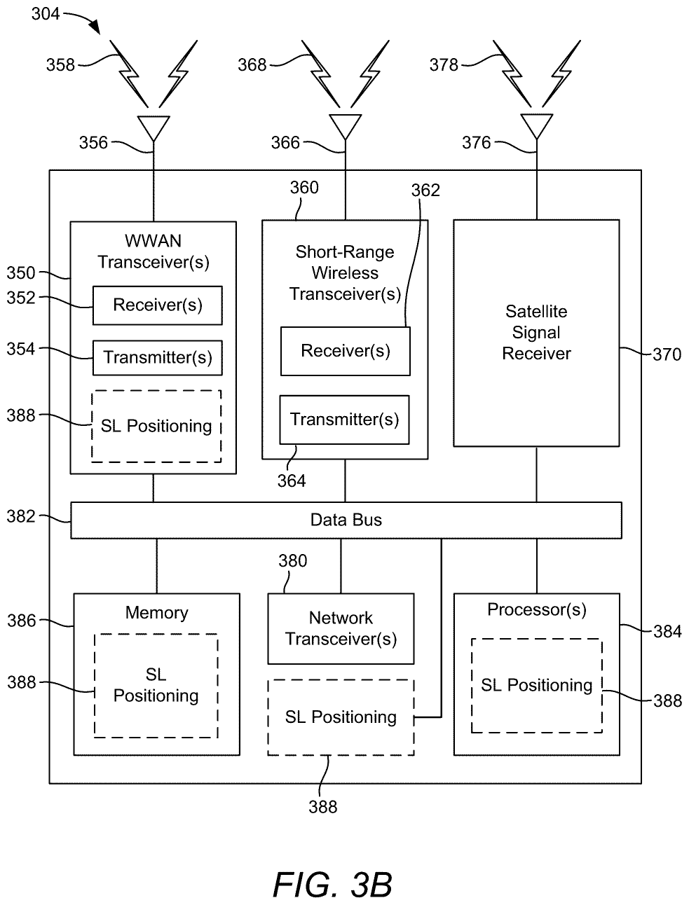

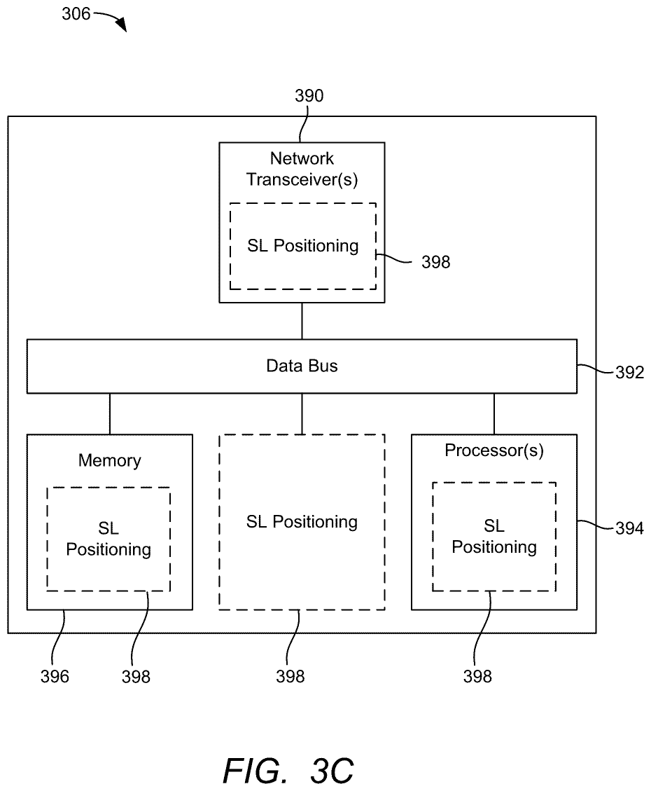

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave200 , PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include sidelink positioning module 342, 388, and 398, respectively. The sidelink positioning module 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the sidelink positioning module 342, 388, and 398 may be external to the processors 332, 384, and 394 (e.g., part of a modem processing system, integrated with another processing system, etc.). Alternatively, the sidelink positioning module 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the sidelink positioning module 342, which may be, for example, part of the one or more WWAN transceivers 310, the memory 340, the one or more processors 332, or any combination thereof, or may be a standalone component. FIG. 3B illustrates possible locations of the sidelink positioning module 388, which may be, for example, part of the one or more WWAN transceivers 350, the memory 386, the one or more processors 384, or any combination thereof, or may be a standalone component. FIG. 3C illustrates possible locations of the sidelink positioning module 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the sidelink positioning module 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

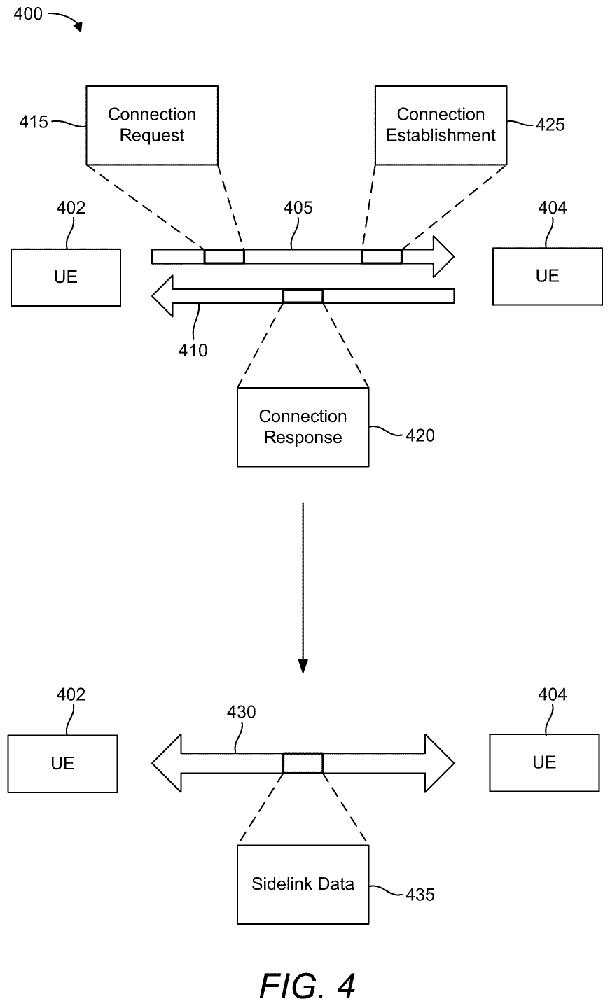

FIG. 4 illustrates an example of a wireless communications system 400 that supports wireless unicast sidelink establishment, according to aspects of the disclosure. In some examples, wireless communications system 400 may implement aspects of wireless communications systems 100, 200, and 250. Wireless communications system 400 may include a first UE 402 and a second UE 404, which may be examples of any of the UEs described herein. As specific examples, UEs 402 and 404 may correspond to V-UEs 160 in FIG. 1, UE 190 and UE 104 in FIG. 1 connected over sidelink 192, or UEs 204 in FIGS. 2A and 2B.

In the example of FIG. 4, the UE 402 may attempt to establish a unicast connection over a sidelink with the UE 404, which may be a V2X sidelink between the UE 402 and UE 404. As specific examples, the established sidelink connection may correspond to sidelinks 162 and/or 168 in FIG. 1 or sidelink 242 in FIGS. 2A and 2B. The sidelink connection may be established in an omni-directional frequency range (e.g., FR1) and/or a mmW frequency range (e.g., FR2). In some cases, the UE 402 may be referred to as an initiating UE that initiates the sidelink connection procedure, and the UE 404 may be referred to as a target UE that is targeted for the sidelink connection procedure by the initiating UE.

For establishing the unicast connection, access stratum (AS) (a functional layer in the UMTS and LTE protocol stacks between the RAN and the UE that is responsible for transporting data over wireless links and managing radio resources, and which is part of Layer 2) parameters may be configured and negotiated between the UE 402 and UE 404. For example, a transmission and reception capability matching may be negotiated between the UE 402 and UE 404. Each UE may have different capabilities (e.g., transmission and reception, 64 quadrature amplitude modulation (QAM), transmission diversity, carrier aggregation (CA), supported communications frequency band(s), etc.). In some cases, different services may be supported at the upper layers of corresponding protocol stacks for UE 402 and UE 404. Additionally, a security association may be established between UE 402 and UE 404 for the unicast connection. Unicast traffic may benefit from security protection at a link level (e.g., integrity protection). Security requirements may differ for different wireless communications systems. For example, V2X and Uu systems may have different security requirements (e.g., Uu security does not include confidentiality protection). Additionally, IP configurations (e.g., IP versions, addresses, etc.) may be negotiated for the unicast connection between UE 402 and UE 404.

In some cases, UE 404 may create a service announcement (e.g., a service capability message) to transmit over a cellular network (e.g., cV2X) to assist the sidelink connection establishment. Conventionally, UE 402 may identify and locate candidates for sidelink communications based on a basic service message (BSM) broadcasted unencrypted by nearby UEs (e.g., UE 404). The BSM may include location information, security and identity information, and vehicle information (e.g., speed, maneuver, size, etc.) for the corresponding UE. However, for different wireless communications systems (e.g., D2D or V2X communications), a discovery channel may not be configured so that UE 402 is able to detect the BSM(s). Accordingly, the service announcement transmitted by UE 404 and other nearby UEs (e.g., a discovery signal) may be an upper layer signal and broadcasted (e.g., in an NR sidelink broadcast). In some cases, the UE 404 may include one or more parameters for itself in the service announcement, including connection parameters and/or capabilities it possesses. The UE 402 may then monitor for and receive the broadcasted service announcement to identify potential UEs for corresponding sidelink connections. In some cases, the UE 402 may identify the potential UEs based on the capabilities each UE indicates in their respective service announcements.

The service announcement may include information to assist the UE 402 (e.g., or any initiating UE) to identify the UE transmitting the service announcement (UE 404 in the example of FIG. 4). For example, the service announcement may include channel information where direct communication requests may be sent. In some cases, the channel information may be RAT-specific (e.g., specific to LTE or NR) and may include a resource pool within which UE 402 transmits the communication request. Additionally, the service announcement may include a specific destination address for the UE (e.g., a Layer 2 destination address) if the destination address is different from the current address (e.g., the address of the streaming provider or UE transmitting the service announcement). The service announcement may also include a network or transport layer for the UE 402 to transmit a communication request on. For example, the network layer (also referred to as “Layer 3” or “L3”) or the transport layer (also referred to as “Layer 4” or “L4”) may indicate a port number of an application for the UE transmitting the service announcement. In some cases, no IP addressing may be needed if the signaling (e.g., PC5 signaling) carries a protocol (e.g., a real-time transport protocol (RTP)) directly or gives a locally generated random protocol. Additionally, the service announcement may include a type of protocol for credential establishment and QoS-related parameters.

After identifying a potential sidelink connection target (UE 404 in the example of FIG. 4), the initiating UE (UE 402 in the example of FIG. 4) may transmit a connection request 415 to the identified target UE 404. In some cases, the connection request 415 may be a first RRC message transmitted by the UE 402 to request a unicast connection with the UE 404 (e.g., an “RRCDirectConnectionSetupRequest” message). For example, the unicast connection may utilize the PC5 interface for the sidelink, and the connection request 415 may be an RRC connection setup request message. Additionally, the UE 402 may use a sidelink signaling radio bearer 405 to transport the connection request 415.

After receiving the connection request 415, the UE 404 may determine whether to accept or reject the connection request 415. The UE 404 may base this determination on a transmission/reception capability, an ability to accommodate the unicast connection over the sidelink, a particular service indicated for the unicast connection, the contents to be transmitted over the unicast connection, or a combination thereof. For example, if the UE 402 wants to use a first RAT to transmit or receive data, but the UE 404 does not support the first RAT, then the UE 404 may reject the connection request 415. Additionally or alternatively, the UE 404 may reject the connection request 415 based on being unable to accommodate the unicast connection over the sidelink due to limited radio resources, a scheduling issue, etc. Accordingly, the UE 404 may transmit an indication of whether the request is accepted or rejected in a connection response 420. Similar to the UE 402 and the connection request 415, the UE 404 may use a sidelink signaling radio bearer 410 to transport the connection response 420. Additionally, the connection response 420 may be a second RRC message transmitted by the UE 404 in response to the connection request 415 (e.g., an “RRCDirectConnectionResponse” message).

In some cases, sidelink signaling radio bearers 405 and 410 may be the same sidelink signaling radio bearer or may be separate sidelink signaling radio bearers. Accordingly, a radio link control (RLC) layer acknowledged mode (AM) may be used for sidelink signaling radio bearers 405 and 410. A UE that supports the unicast connection may listen on a logical channel associated with the sidelink signaling radio bearers. In some cases, the AS layer (i.e., Layer 2) may pass information directly through RRC signaling (e.g., control plane) instead of a V2X layer (e.g., data plane).

If the connection response 420 indicates that the UE 404 accepted the connection request 415, the UE 402 may then transmit a connection establishment 425 message on the sidelink signaling radio bearer 405 to indicate that the unicast connection setup is complete. In some cases, the connection establishment 425 may be a third RRC message (e.g., an “RRCDirectConnectionSetupComplete” message). Each of the connection request 415, the connection response 420, and the connection establishment 425 may use a basic capability when being transported from one UE to the other UE to enable each UE to be able to receive and decode the corresponding transmission (e.g., the RRC messages).

Additionally, identifiers may be used for each of the connection request 415, the connection response 420, and the connection establishment 425. For example, the identifiers may indicate which UE 402/304 is transmitting which message and/or for which UE 402/304 the message is intended. For physical (PHY) layer channels, the RRC signaling and any subsequent data transmissions may use the same identifier (e.g., Layer 2 IDs). However, for logical channels, the identifiers may be separate for the RRC signaling and for the data transmissions. For example, on the logical channels, the RRC signaling and the data transmissions may be treated differently and have different acknowledgement (ACK) feedback messaging. In some cases, for the RRC messaging, a physical layer ACK may be used for ensuring the corresponding messages are transmitted and received properly.

One or more information elements may be included in the connection request 415 and/or the connection response 420 for UE 402 and/or UE 404, respectively, to enable negotiation of corresponding AS layer parameters for the unicast connection. For example, the UE 402 and/or UE 404 may include packet data convergence protocol (PDCP) parameters in a corresponding unicast connection setup message to set a PDCP context for the unicast connection. In some cases, the PDCP context may indicate whether or not PDCP duplication is utilized for the unicast connection. Additionally, the UE 402 and/or UE 404 may include RLC parameters when establishing the unicast connection to set an RLC context for the unicast connection. For example, the RLC context may indicate whether an AM (e.g., a reordering timer (t-reordering) is used) or an unacknowledged mode (UM) is used for the RLC layer of the unicast communications.

Additionally, the UE 402 and/or UE 404 may include medium access control (MAC) parameters to set a MAC context for the unicast connection. In some cases, the MAC context may enable resource selection algorithms, a hybrid automatic repeat request (HARQ) feedback scheme (e.g., ACK or negative ACK (NACK) feedback), parameters for the HARQ feedback scheme, carrier aggregation, or a combination thereof for the unicast connection. Additionally, the UE 402 and/or UE 404 may include PHY layer parameters when establishing the unicast connection to set a PHY layer context for the unicast connection. For example, the PHY layer context may indicate a transmission format (unless transmission profiles are included for each UE 402/304) and a radio resource configuration (e.g., bandwidth part (BWP), numerology, etc.) for the unicast connection. These information elements may be supported for different frequency range configurations (e.g., FR1 and FR2).

In some cases, a security context may also be set for the unicast connection (e.g., after the connection establishment 425 message is transmitted). Before a security association (e.g., security context) is established between the UE 402 and UE 404, the sidelink signaling radio bearers 405 and 410 may not be protected. After a security association is established, the sidelink signaling radio bearers 405 and 410 may be protected. Accordingly, the security context may enable secure data transmissions over the unicast connection and the sidelink signaling radio bearers 405 and 410. Additionally, IP layer parameters (e.g., link-local IPv4 or IPv6 addresses) may also be negotiated. In some cases, the IP layer parameters may be negotiated by an upper layer control protocol running after RRC signaling is established (e.g., the unicast connection is established). As noted above, the UE 404 may base its decision on whether to accept or reject the connection request 415 on a particular service indicated for the unicast connection and/or the contents to be transmitted over the unicast connection (e.g., upper layer information). The particular service and/or contents may be also indicated by an upper layer control protocol running after RRC signaling is established.

After the unicast connection is established, the UE 402 and UE 404 may communicate using the unicast connection over a sidelink 430, where sidelink data 435 is transmitted between the two UEs 402 and 404. The sidelink 430 may correspond to sidelinks 162 and/or 168 in FIG. 1 and/or sidelink 242 in FIGS. 2A and 2B. In some cases, the sidelink data 435 may include RRC messages transmitted between the two UEs 402 and 404. To maintain this unicast connection on sidelink 430, UE 402 and/or UE 404 may transmit a keep alive message (e.g., “RRCDirectLinkAlive” message, a fourth RRC message, etc.). In some cases, the keep alive message may be triggered periodically or on-demand (e.g., event-triggered). Accordingly, the triggering and transmission of the keep alive message may be invoked by UE 402 or by both UE 402 and UE 404. Additionally or alternatively, a MAC control element (CE) (e.g., defined over sidelink 430) may be used to monitor the status of the unicast connection on sidelink 430 and maintain the connection. When the unicast connection is no longer needed (e.g., UE 402 travels far enough away from UE 404), either UE 402 and/or UE 404 may start a release procedure to drop the unicast connection over sidelink 430. Accordingly, subsequent RRC messages may not be transmitted between UE 402 and UE 404 on the unicast connection.

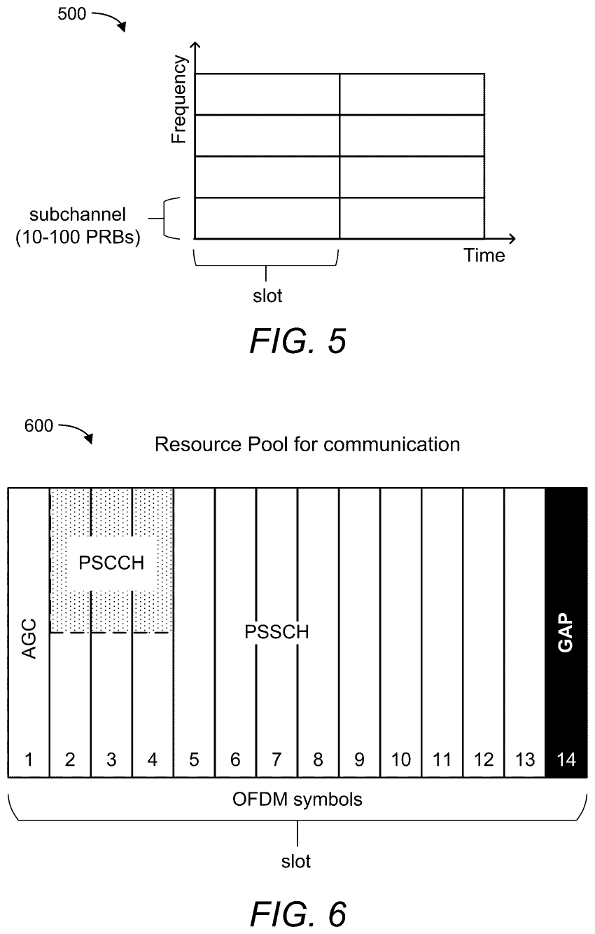

FIG. 5 illustrates a resource pool 500. The minimum resource allocation for a resource pool in the frequency domain is a subchannel. Each subchannel comprises a number (e.g., 10, 15, 20, 25, 50, 75, or 100) of physical resource blocks (PRBs). The resource allocation for a resource pool in the time domain is in whole slots. Each slot contains a number (e.g., 14) of orthogonal frequency domain multiplexing (OFDM) symbols.

FIG. 6 illustrates a conventional resource pool 600 used for sidelink communications. Sidelink communications occupy one slot and one or more subchannels. Some slots are not available for sidelink, and some slots contain feedback resources. Sidelink communication can be preconfigured (e.g., preloaded on a UE) or configured (e.g., by a base station via RRC). A sidelink communication can be (pre) configured to occupy fewer than 14 symbols in a slot. The first symbol of the slot is repeated on the preceding symbol for automatic gain control (AGC) settling. The example slot shown in FIG. 6 contains a physical sidelink control channel (PSCCH) portion and a physical sidelink shared channel (PSSCH) portion, with a gap symbol following the PSCCH.

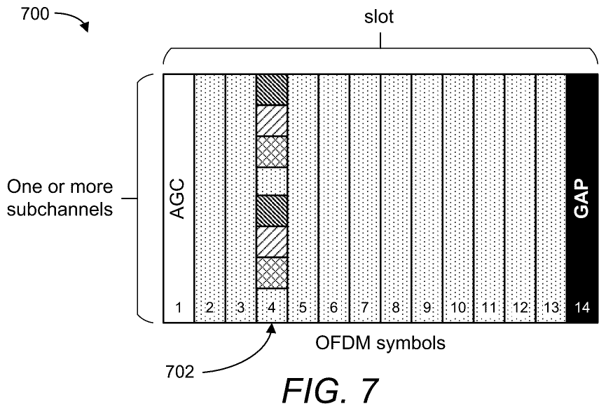

FIG. 7 illustrates a resource pool used for sidelink or other positioning-referred to herein as a “resource pool for positioning” (RPP) 700 according to some aspects of the disclosure. In FIG. 7, RPP 700 occupies one or more subchannels in the frequency domain and one slot in the time domain and contains resources that can be allocated for sidelink transmission. In FIG. 7, each slot comprises fourteen OFDM symbols, with OFDM symbol 1 being reserved for AGC and OFDM symbol 14 being reserved as a gap symbol. In FIG. 7, the RPP occupies all of the remaining symbols 2-13.

In some aspects, the size and shape of an RPP is defined by an RPP configuration. An RPP configuration can specify attributes of the RPP, including, but not limited to the location of the RPP in the time domain, e.g., the slot, the symbol offset into the slot, the number of consecutive symbols that it occupies within the slot, a periodicity, etc.; the location of the RPP in the frequency domain, e.g., the starting frequency (e.g., the starting component carrier), the bandwidth within or across multiple component carriers, etc. In some aspects, each RPP can be associated with a geographic zone or a distance from a reference location.

RPP 700 includes resources 702 in which sidelink UEs can transmit or receive sidelink positioning reference signals (SL-PRSs). The SL-PRS design uses a comb-based pattern for FFT-based processing at the receiver. The DL-PRSs are un-staggered or partially staggered for a small range or time of arrival (ToA) uncertainty and reduced overhead of each SL-PRS resource. The SL-PRS is associated with a particular RPP, which enables a wideband and periodic opportunity for SL-PRS transmission and reception across multiple UEs decoupled from the physical sidelink shared channel (PSSCH) allocation. Intra-slot repetition allows for combining gains if needed. Inter-UE coordination of RPPs allows for dynamic PRS and data multiplexing while minimizing SL-PRS collisions.

A gNB or other base station may assign one or more RPP configurations to a UE, either directly or via another UE that operates as a relayer or repeater. In some aspects, a UE may assign one or more RPP configurations to another UE. For example, a relay UE may assign one or more RPP configurations to a remote UE that the relay UE is serving.

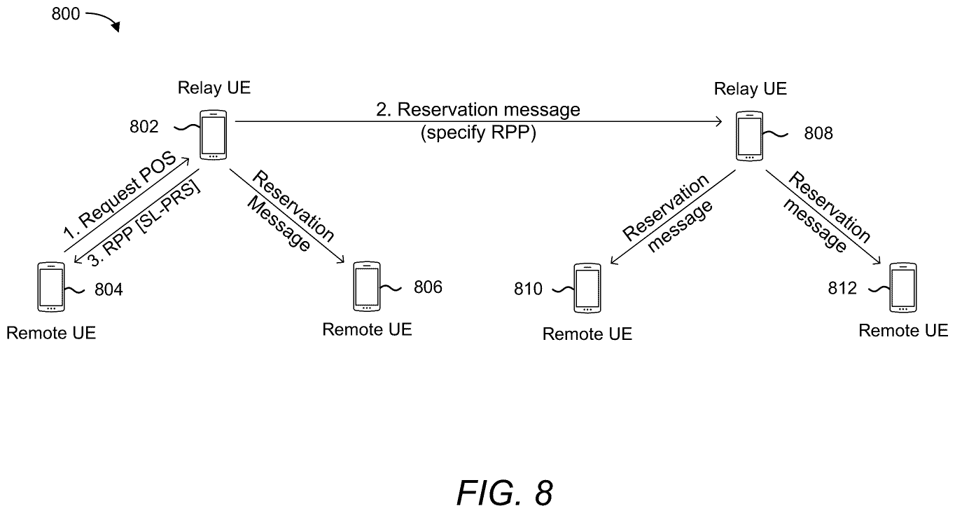

FIG. 8 illustrates a method 800 for coordinated reservation of SL RPPs according to aspects of the disclosure. In FIG. 8, a first relay UE 802 is serving remote UE 804 and remote UE 806, and a second relay UE 808 is serving remote UE 810 and remote UE 812. The number of relay UEs and the number of remote UEs that each relay UE serves can vary; these numbers are illustrative and not limiting. Each of the UEs is configured with a predefined set of RPPs. The predefined plurality of RPPs may be preloaded on the UE or configured by a serving base station, e.g., via RCC.

In method 800, a UE determines that a RPP from the predefined plurality of RPPs should be reserved. In the example shown in FIG. 8, the relay UE 802 receives, from a remote UE 804, a request for a RPP from the predefined plurality of RPPs. The remote UE 804 may issue a general request for any available RPP, in which case the relay UE 802 may select one of the RPPs from the predefined set of RPPs. Alternatively, the remote UE 804 may request a specific RPP, in which case the relay UE 802 may select that specific RPP, or the relay UE 802 may select a different RPP, e.g., such as when the requested RPP is unavailable due to being reserved by another remote UE or for some other reason.

In response, relay UE 802 transmits a reservation message for reserving a specified RPP. The reservation message may be transmitted via a broadcast, groupcast, or multicast message. The reservation message may be transmitted via a physical sidelink control channel (PSCCH), a physical sidelink shared channel (PSSCH), or a combination thereof. In one aspect, the reservation message is transmitted to the remote UE 806 and to the relay UE 808, and the relay UE 808 relays the message to the remote UE 810 and remote UE 812. Alternatively, the reservation message is transmitted to the relay UE 808, the remote UE 806, the remote UE 810, and the remote UE 812 simultaneously. Alternatively, the relay UE 802 may send a set of unicast messages to neighboring UEs.

The reservation message may include additional information, such as, but not limited to, the following. The reservation message may indicate that a sidelink positioning reference signal (SL-PRS) will be transmitted using the reserved RPP. The reservation message may specify particular SL-PRS resources within the RPP that will be used. The reservation message may identify the remote UE that will use the reserved RPP. The reservation message may include an RPP identifier. The reservation message may include a zone identifier that specifies the geographic zone or zones to which the reservation applies.

The reservation message may include a priority indication that specifies the relative priority of a positioning operation to other types of operations that might also use the resources of the RPP. For example, if the priority of the positioning operation is higher than the priority of a data or reference signal transmission by a neighboring UE, then the neighboring UEs are expected to avoid scheduling; otherwise, the neighboring UEs can schedule also.

The reservation request may include or imply a request that the UEs receiving the reservation request (and that are within the specified zone, if applicable) reduce interference during the reserved RPP, e.g., by rate-matching, muting, puncturing, reducing transmit power, or combinations thereof, during the reserved RPP, and, if applicable, within the specified SL-PRS resources. In the example shown in FIG. 8, the relay UE 808, the remote UE 806, the remote UE 810, and the remote UE 812 may respond to the reservation request, e.g., by modifying an intended transmission to reduce interference with the remote UE 806 during the reserved RPP.

In some aspects, the reservation message may include timing information associated with the reservation, such as, but not limited to, the timing information associated with the reservation comprises a start time of the RPP, a stop time of the RPP, a time offset of the RPP, a periodicity of the RPP, an indicator that the RPP does not repeat (e.g., that this is a single-shot request), or combinations thereof. In the example illustrated in FIG. 8, the relay UE 600A sends the reservation message, but alternatively, the remote UE 804 may send the reservation message.

In FIG. 8, the relay UE 802 then sends a configuration message to remote UE 804. The configuration message identifies the RPP to be used by remote UE 804 and may also specify a subset of SL-PRS resources within the RPP to be used by remote UE 804. In some aspects, the SL-PRS resources within the reserved RPP may be identified by an index. If a time domain index is used, the time-domain index may be relative to the RPP. The SL-PRS resources to be used by the remote UE 804 may include all or a portion of the SL-PRS resources within the reserved RPP.

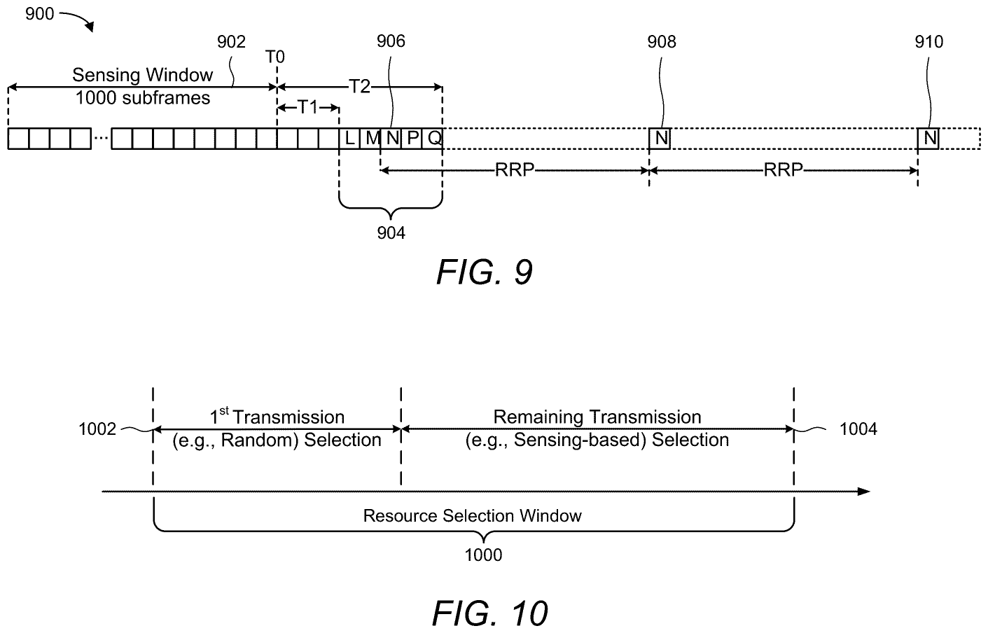

FIG. 8 illustrates a process for reserving a specified RPP, but how does the UE select the specified RPP? One approach, referred to as “autonomous selection” uses a set of rules that, if obeyed by all UEs, result in nearly collision free transmission or use of shared resources for SL data transmissions. An example is illustrated in FIG. 9.

FIG. 9 illustrates a process 900 for autonomous selection of subframes for SL data transmissions, according to aspects of the disclosure. In FIG. 9, a UE continually monitors some previous number of subframes during what is referred to as the sensing window 902. In FIG. 9, the sensing window 902 is 1000 subframes, but other numbers of subframes may be used instead. During the sensing window 902, the UE attempts to identify shared subframes that may be candidates for possible use by the UE for SL data transmissions.

In the example shown in FIG. 9, at time TO, the UE determines that a SL data transmission is needed. This may be the result of an internal request, such as from an application on the UE, or an external request, such as from another sidelink UE. Internally, the UE has a processing time of T1, meaning that the UE can't transmit the SL data sooner than time T1 from the request, and the application requires the SL data to be transmitted no later than time T2 from the request. This creates a window 904 of time from which a subframe must be selected.

In the example shown in FIG. 9, the UE selects a subframe 906, labeled subframe “N” in FIG. 9, in which to transmit the first transmit block (TB) of the SL data. In some aspects, subframe N may be randomly selected from among the subframes that were identified as candidate subframes during the sensing window 902. In some aspects, the UE may randomly select any of the subframes within the window 904. In NR vehicle to infrastructure (V2X) SL communications, for example, it is allowed to transmit the initial TB without a prior reservation, based on a sensing and resource selection procedure, and reserve sidelink resources for transmissions of subsequent TB, e.g., via sidelink control information (SCI) associated with transmission of the previous TB. Thus, in some aspects, the initial transmission 906 is made without a prior reservation, i.e., subframe N is selected based on the sensing and resource selection procedure, but later transmissions 908, 910, and so on are reserved in advance, e.g., at or around the time of the initial transmission 906. For example, the sidelink control information (SCI) associated with the transmission of one TB may include a reservation for transmission of the next TB. In some aspects, the subsequent transmissions 908 and 910 may be reserved via standalone PSSCH transmissions.

In some aspects, once a subframe 906 has been selected, such as subframe N in FIG. 9, later transmissions of subsequent TBs of SL data will also use the Nth subframe. In the example shown in FIG. 9, the next TB of SL data will be transmitted every resource reservation period (RPP), i.e., at subframe 908 and again at subframe 910. That is, later transmissions will be made in subframe N+RRP, N+2*RRP, and so on, up to N+ (slctr−1)*RPP, where slctr is a maximum slot count. In some aspects, the value of RRP is chosen by the UE from a set of valid values provided as part of an access configuration. Example values of RRP may include {20, 40, 100, 200, . . . 1000} milliseconds. In some aspects, the value of slctr may be randomly selected from a certain range, depending on the RRP value, e.g., between 5 and 15 for RRP=100. In some aspects, the ranges are specified in a MAC specification, and the UE needs to transmit the RRP value in some control information.

While the UE is repeating the transmissions (906, 908, 910, etc.), the UE continues to monitor subframes during the rolling sensing window of the 1000 previous subframes. If the UE detected transmissions from other UEs during specific subframes of the sensing window, such as subframe L, M, P, or Q, etc., then those subframes should be removed from the set of candidate subframes for the next selection.

This raises the possibility that all of the subframes are eliminated as candidates. In that circumstance, the UE may add back in some of the subframes that had previously been eliminated as candidates. For example, if the UE detected a transmission from another entity on subframe Q, that subframe may be eliminated from the candidate list, but if a sufficient number of subframes (e.g., 20%) are not available, and the transmission on subframe Q had a low signal strength, then subframe Q may be added back into the list of candidate subframes, e.g., because the other UE is far enough away to not interfere with a transmission by first UE. In some aspects, the subframes having the weakest signals are added back in, and if more subframes are needed, subframes having slightly stronger signals are added back in, and so on, until a sufficient number of subframes are available.

After the slctr number of transmissions have been completed, in some aspects the UE can repeat the process of selecting an initial subframe-perhaps subframe L this time-based on the most recent sensing window 902 and repeating SL data transmissions on subframe L+RRP, L+2*RRP, and so on. Here also, a new value for slctr may be randomly selected from the configured range of possible values for slctr. Alternatively, the UE may determine that it is better to continue to use subframe N.

Yet another rule may be that a UE stops using the autonomously selected subframes (e.g., N, N+RRP, etc.) after a threshold number of transmit opportunities are not used by the UE, where this threshold number may also be part of an access configuration.

Thus, in SL Mode2, which does not require a base station, the process of resource allocation follows this sequence: at time T_{A}, when the SL data arrives at the transmit buffer, the UE determines the selection window for the initial reservation, identifies the available subchannels within the selection window, and selects resources for the initial reservation, which occurs at time T_{R}. The initial reservation at time T_{R} reserves resources at time T_{T1} for SL data transmission. At time T_{T1}, the UE determines the selection window for the next transmission, identifies the available subchannels within the selection window, selects resources for the next transmission, which will occur at time T_{T2}, reserves those resources, and performs the data transmission at time T_{T1}.

An example conventional configuration of selection window size is shown below:

```
SL-UE-SelectedConfigRP-r16 ::=
  SEQUENCE {
    sl-CBR-PriorityTxConfigList-r16
```

| | |
|---|---|
| SL-CBR-PriorityTxConfigList-r16 | OPTIONAL, -- Need M |

sl-Thres-RSRP-List-r16

| | |
|---|---|
| SL-Thres-RSRP-List-r16 | OPTIONAL, -- Need M |

sl-MultiReserveResource-r16

| | |
|---|---|
| ENUMERATED {enabled} | OPTIONAL, -- Need M |

sl-MaxNumPerReserve-r16

| | |
|---|---|
| ENUMERATED {n2, n3} | OPTIONAL, -- Need M |

sl-SensingWindow-r16

| | |
|---|---|
| ENUMERATED {, ms1100} | OPTIONAL, -- Need M |

sl-SelectionWindowList-r16

| | |
|---|---|
| SL-SelectionWims100ndowList-r16 | OPTIONAL, -- Need M |

```
    sl-ResourceReservePeriodList-r16
      SEQUENCE (SIZE (1..16)) OF
```

| | |
|---|---|
| SL-ResourceReservePeriod-r16 | OPTIONAL, -- Need M |

```
    sl-RS-ForSensing-r16
      ENUMERATED {pscch, pssch},
    ...,
    [[
    sl-CBR-PriorityTxConfigList-v1650
```

| | |
|---|---|
| SL-CBR-PriorityTxConfigList-v1650 | OPTIONAL, -- Need M |

```
    ]]
  }
SL-SelectionWindowList-r16 ::=
  SEQUENCE (SIZE (8)) OF SL-SelectionWindowConfig-r16
SL-SelectionWindowConfig-r16 ::=
  SEQUENCE {
    sl-Priority-r16
      INTEGER (1..8),
    sl-SelectionWindow-r16
      ENUMERATED {n1, n5, n10, n20}
  }
```

The conventional configuration shown above defines a sensing window (sl-SensingWindow-r16) and a list (sl-SelectionWindowList-r16) of eight selection windows having different priorities (SL-SelectionWindowConfig-r16).

However, conventional networks define only one set of SL selection windows, and do not separately specify selection windows for SL positioning. The requirements for SL positioning may be quite different from the requirements for SL data transmission. For example, the size of a sensing window needed to identify resources that may be available for SL positioning may be different from the size of a sensing window needed to identify resources that may be available for SL data transmission.

Accordingly, techniques for providing multiple selection windows for SL positioning are herein presented. Where SL positioning uses a resource pool for positioning (RPP), these techniques provide multiple selection windows within a SL-RPP. In some aspects, each of the multiple selection windows may have their own separate configuration.

An example configuration of selection window size according to aspects of the disclosure is shown below, with new information elements shown in bold font:

```
SL-UE-SelectedConfigRP-r16 ::=
  SEQUENCE {
    sl-CBR-PriorityTxConfigList-r16
```

| | |
|---|---|
| SL-CBR-PriorityTxConfigList-r16 | OPTIONAL, -- Need M |

sl-Thres-RSRP-List-r16

| | |
|---|---|
| SL-Thres-RSRP-List-r16 | OPTIONAL, -- Need M |

sl-MultiReserveResource-r16

| | |
|---|---|
| ENUMERATED {enabled} | OPTIONAL, -- Need M |

sl-MaxNumPerReserve-r16

| | |
|---|---|
| ENUMERATED {n2, n3} | OPTIONAL, -- Need M |

sl-SensingWindow-r16

| | |
|---|---|
| ENUMERATED {, ms1100} | OPTIONAL, -- Need M |

sl-SelectionWindowList-r16

| | |
|---|---|
| SL-SelectionWims100ndowList-r16 | OPTIONAL, -- Need M |

sl-SensingWindowPos-r17

| | |
|---|---|
| ENUMERATED {ms100, ms1100} | OPTIONAL, -- Need M |

sl-SelectionWindowListPos-r17

| | |
|---|---|
| SL-SelectionWindowListPos-r16 | OPTIONAL, -- Need M |

```
    sl-ResourceReservePeriodList-r16
      SEQUENCE (SIZE (1..16)) OF
```

| | |
|---|---|
| SL-ResourceReservePeriod-r16 | OPTIONAL, -- Need M |

```
    sl-RS-ForSensing-r16
      ENUMERATED {pscch, pssch},
    ...,
    [[
    sl-CBR-PriorityTxConfigList-v1650
```

| | |
|---|---|
| SL-CBR-PriorityTxConfigList-v1650 | OPTIONAL, -- Need M |

```
    ]]
  }
SL-SelectionWindowListPos-r16 ::=
  SEQUENCE (SIZE (8)) OF SL-SelectionWindowConfigPos-r17
SL-SelectionWindowConfigPos-r17 ::=
  SEQUENCE {
    sl-PriorityPos-r17
      INTEGER (1..4),
    sl-PosResourceConfigList-r17
      sl-PosResourceConfigList,
    sl-SelectionWindowPos-r17
      ENUMERATED {n1, n5, n10, n20}
    sl-SelectionWindowPosReponse-R17
      ENUMERATED {m1, m2, m3, m4}
  }
```

As shown in the example configuration above, several new information elements are defined, listed in the table below:

TABLE 1

| IE/field | Description/Purpose |
|---|---|
| sl-SensingWindowPos | Specifies the duration of a sensing window for |
| | sensing resources used for SL positioning. |
| sl-SelectionWindowListPos | A list of selection windows for SL positioning |
| | configurations. In this example, only eight |
| | selection windows are defined, but this number is |
| | illustrative and not limiting. |
| SL-SelectionWindowConfigPos | Specifies a configuration of one selection window |
| | for SL positioning. |
| sl-PriorityPos | Specifies a priority associated with the selection |
| | window for SL positioning. In this example, only |
| | four different priority levels are needed, but this |
| | number is illustrative and not limiting. |
| sl-PosResourceConfigList | A list of configurations for positioning resource |
| | selection windows. |
| sl-SelectionWindowPos | Specifies a selection window containing |
| | resources for transmitting a SL positioning signal. |
| sl-SelectionWindowPosResponse | Specifies a selection window containing |
| | resources for receiving a response to the |
| | transmitted SL positioning signal. |

Thus, a single resourced pool for positioning can have multiple selection windows for SL positioning, that are configured independently of selection windows used for SL data transmission. In some aspects, each selection window for SL positioning can be independently configured from the other selection windows for SL positioning.

In some aspects, a selection configuration may include one or more of the following fields: a field that indicates a sensing type (e.g., full sensing, partial sensing, or random selection), a field that indicates the minimum and maximum number of sub-channels which may be used for transmissions on SL-PRS, a field that indicates a maximum number of SL-PRS transmissions (including new transmission and retransmission), and a field that indicates a maximum transmit power for the SL-PRS signals. In some aspects, the selection configuration may specify the length of each selection window. In some aspects, the selection configuration may specify a per-slot probability of selecting one of the available resources within that slot. In some aspects, the selection configuration may indicate a bandwidth for SL-PRS signals in each window. In some aspects, the selection configuration may indicate the length of consecutive slots available for SL-PRS repetitions, e.g., for multi-slot SL-PRS reservations.

It has been determined that, for SL data transmission, allowing the UE to select from among the earliest available resources in the selection window significantly reduces packet reception latency and can also improve performance. Thus, it has been proposed that, for SL data transmission, multiple selection windows may be defined. In some aspects, the overall resource selection window is segmented into two windows, as shown in FIG. 10.

FIG. 10 illustrates a segmented selection window for SL data transmission, according to aspects of the disclosure. In FIG. 10, a resource selection window 1000 is divided into a 1^{st} segment 1002 and a second segment 1004. The first segment 1002 is for selection of the first transmission, and the second segment 1004 is for selection of subsequent transmissions. In this manner, the overall resource selection window is segmented into two windows. The window for the initial transmission is smaller, forcing the selection of an early resource, while still providing randomization in resources to avoid collisions. Due to reservations being limited to a window of 32 slots in the future, only the first portion of the resource selection has information about resource availability. The remaining portion would all be considered as available resources. This favors selection of later candidates in the selection window, further increasing latency and impacting performance in the high PRR region.

It has been agreed that for SL Mode2 data transmissions, the resource pool can be configured or pre-configured to enable full sensing only, partial sensing only, random resource selection only, or combinations of full sensing, partial sensing, and random selection. It has been agreed that random resource selection may be used for both period and aperiodic transmissions.

Where some UEs perform full or partial sensing but other UEs perform random selection, this can cause some undesirable inefficiencies, however. For example, a UE may randomly select a resource that another UE has selected based on sensing, which causes a collision. Likewise, a UE may select a resource based on a determination, based on sensing, that the resource is available, only to have that resource be randomly selected by another UE, again causing a collision. Also, an increasing number of SL-UEs performing random selection increases the risk of collisions, which degrades performance.

One way to overcome this problem is to configure a part of the resource pools for random resource selection only. This way, resource collision between users performing random and sensing-based resource selection in a mixed resource pool can be avoided. Consequently, the dedicated resource pools or dedicated resources within resource pools for random resource selection could be configured to mitigate resource collisions to meet the required quality of service (QOS) requirements. While such techniques have been discussed for SL data communication, none of them have been considered for SL positioning.

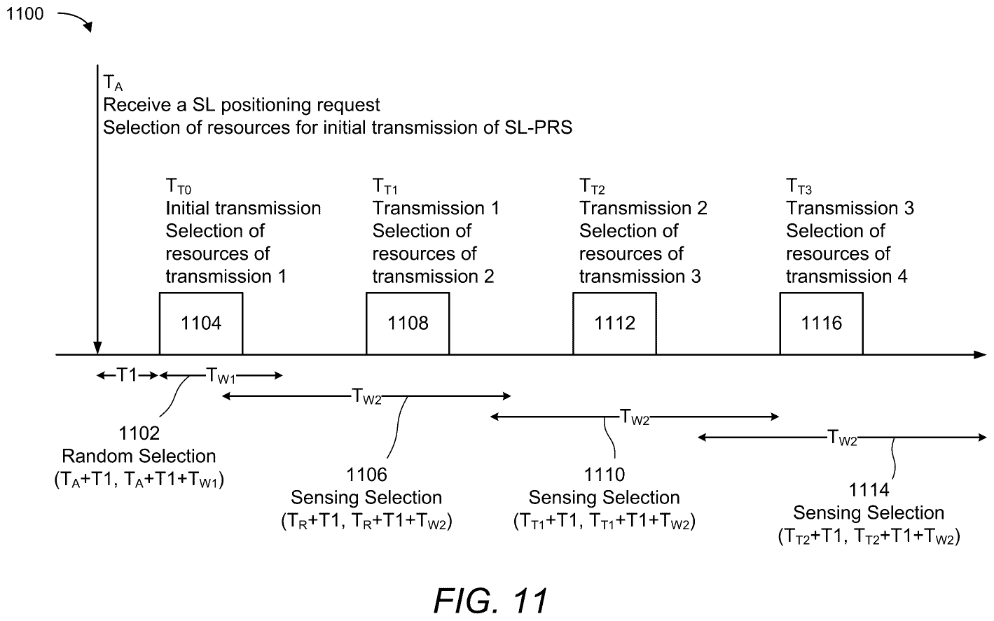

Accordingly, in some aspects of the disclosure, a selection window may be divided into segments, such as a first segment reserved for random resource selection and a second segment for sensing-based resource selection. An example of this is illustrated in FIG. 11.

FIG. 11 illustrates another example 1100 of multiple selection windows for an SL-RPP, according to aspects of the disclosure. In the example 1100 illustrated in FIG. 11, at time T_{A}, a UE receives an SL positioning request or otherwise determines to transmit an SL-PRS signal. After an internal processing delay of T1, from a first section 1102 of the selection window, the UE randomly selects resources 1104, and at time T_{T0} the UE transmits a first SL-PRS using those resources 1104. During a second section 1106 of the selection window, the UE selects resources 1108 for the second SL-PRS transmission. At time T_{T1}, the UE transmits the second SL-PRS using resources 1108 and, from a second section 1110 of the next selection window, selects resources 1112 for the third SL-PRS transmission. At time T_{T2}. the UE transmits the third SL-PRS using resources 1112 and, from a second section 1114 of the next selection window, selects resources 1116 for the fourth SL-PRS transmission, not shown in FIG. 11.

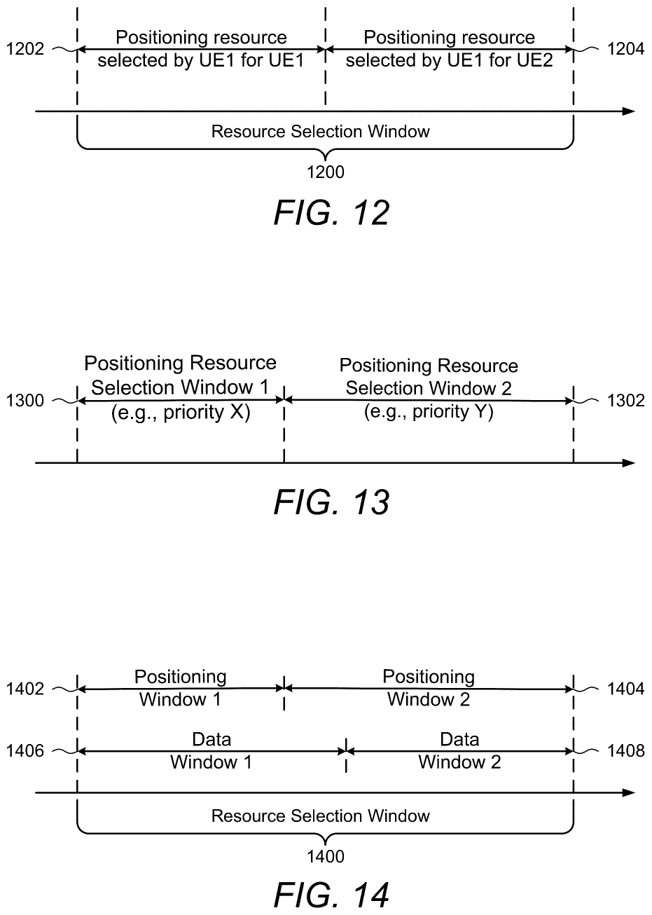

FIG. 12 illustrates another example of multiple selection windows for an SL-RPP, according to aspects of the disclosure. As shown in FIG. 12, a selection window 1200 may be divided into two parts: a first part 1202 used by a first UE (UE1) for positioning resource transmission to a second UE (UE2) or to multiple UEs, and a second part 1204 used by UE1 for reserving positioning resources for use by UE2. Thus, in some aspects, there are separate selection windows for Tx resources for SL positioning and for Rx resources for SL positioning. For example, a Tx resource may be used by UE1 to transmit a SL positioning signal to UE2, and a Rx resource may be used by UE2 to send the response back to UE1. This allows UE1 to simultaneously select SL positioning resources for both itself and for UE2, which obviates the need for UE2 to perform its own resource selection procedure and thus reduces latency. In some aspects, the length of each of the two parts of the selection window may be specified by another entity, e.g., by an anchor UE. In the configuration example above, the enumerated values of {m1, m2, m3, and m4} may be configured, provisioned, or signaled to have particular meaning to both UEs. For example, in one implementation, “m1” indicates that the full length of the selection window is used by UE1, and “m2”, “m3”, and “m4” indicate that the first 70%, 50%, or 25%, respectively, of the length of the selection window is used by UE1, with the remainder to be used by UE2.

For positioning, latency can be an important or critical parameter, and there may be some positioning use cases where a UE has a very tight requirement on positioning latency. In this scenario, a UE may be instructed to try to find a resource within a relatively short selection window. However, if the UE is unable to find an available resource within a short selection window, in some aspects the UE should try to find an available resource within a longer selection window. When multiple selection windows and configurations are available, in some aspects an anchor UE may provide parameters or other form of guidance indicating how and when another UE should change from one selection window to another selection window.

For example, the kinds of parameters that may be provided by the anchor UE may include one or more parameters indicating one or more of the following: how many times the UE should try on each selection window for positioning before moving to another selection window for positioning (in some aspects, each selection window for positioning may have different number of retries); a backoff time for each selection window, in case resource selection failure was detected; or a new priority level, which may be mapped to a corresponding selection window for the UE to use.

FIG. 13 illustrates another example of multiple selection windows for an SL-RPP, according to aspects of the disclosure. In this example, resource selection windows are defined in according to a standard and may be used for both SL data transmission and SL positioning. In this scenario, an anchor UE will define the priority of data versus positioning resource for each positioning occasion, and it is up to the anchor UE to define the dedicated positioning selection window with the common selection window. In the example shown in FIG. 13, a first resource selection window 1300 having a priority X has been defined by the anchor UE to be used for positioning, and a second resource selection window 1302 having a priority Y has been defined by the anchor UE to also be used for positioning.

In some aspects, when multiple selection windows with different configurations are available for SL positioning, a UE may control the movement from one resource selection window for positioning to another resource selection window for positioning. In some aspects, the positioning UE will look for the resource selection window for positioning with the highest priority in the configuration list, and attempt to select one of the available resources within that resource selection window. If the UE cannot find an available resource within that resource selection window, it may try again for a configured number of times N. If the UE continues to fail for all N times, the UE marks this selection window as “not useful” for some amount of time T (after which that selection window may be used again), and then repeats this process with the second highest priority selection window, and so on.

In some aspects, an anchor UE can use this and other types of feedback to change the positioning selection window length, configuration, or priority for the next positioning session. For example, if a selection window has been marked “not useful” a threshold number of times (which may be “one”), the anchor UE can instruct the UE to use a selection window with a larger window length, in the hope that some of the additional resources now available within the larger window will be available for use.

In some aspects, an anchor UE may modify the existing selection window list, e.g., to add, delete, or modify one or more selection window configurations.

FIG. 14 illustrates another example of multiple selection windows for an SL-RPP, according to aspects of the disclosure. FIG. 14 illustrates the point that both SL positioning and SL data may benefit from segmenting a resource selection window 1400 into a random selection section and a sense-based selection section, but that exactly where the resource selection window 1400 is divided may be different for SL positioning versus SL data transmission. In FIG. 14, a resource selection window 1400 is divided into a first segment for positioning 1402 and a second segment for positioning 1404, but into different sized segments for data transfer, e.g., a first segment for data 1406 and a second segment for data 1408.

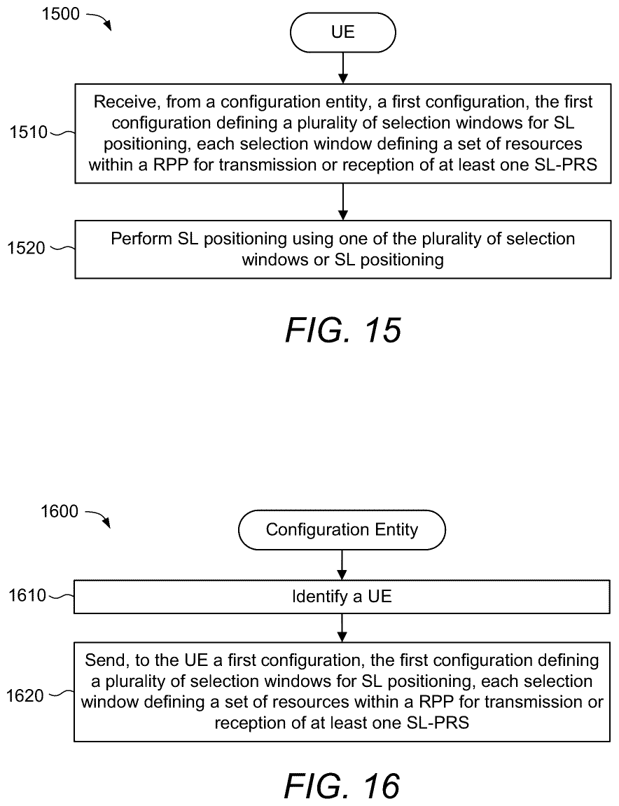

FIG. 15 is a flowchart of an example process 1500 associated with multiple selection windows for a sidelink resource pool for positioning, according to aspects of the disclosure. In some implementations, one or more process blocks of FIG. 15 may be performed by a user equipment (UE) (e.g., UE 104). In some implementations, one or more process blocks of FIG. 15 may be performed by another device or a group of devices separate from or including the UE. Additionally, or alternatively, one or more process blocks of FIG. 15 may be performed by one or more components of UE 302, such as processor(s) 332, memory 340, WWAN transceiver(s) 310, short-range wireless transceiver(s) 320, satellite signal receiver 330, sensor(s) 344, user interface 346, and sidelink positioning module(s) 342, any or all of which may be means for performing the operations of process 1500.

As shown in FIG. 15, at block 1510, process 1500 may include receiving, from a configuration entity, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS). Means for performing the operation of block 1510 may include the processor(s) 332, memory 340, or WWAN transceiver(s) 310 of the UE 302. For example, the UE 302 may receive the first configuration using the receiver(s) 312.

As further shown in FIG. 15, at block 1520, process 1500 may include performing SL positioning using one of the plurality of selection windows for SL positioning. Means for performing the operation of block 1520 may include the processor(s) 332, memory 340, or WWAN transceiver(s) 310 of the UE 302. For example, the UE 302 may perform SL positioning using one of the plurality of selection windows for SL positioning, using the transmitter(s) 314 and the receiver(s) 312.

Process 1500 may include additional implementations, such as any single implementation or any combination of implementations described below and/or in connection with one or more other processes described elsewhere herein.

In some aspects, each of the plurality of selection windows defined by the first configuration is associated with at least one of the following parameters: a sensing type, comprising at least one of random selection, full sensing, or partial sensing, to be performed during the selection window; a priority; a minimum number of sub-channels; a maximum number of sub-channels; a maximum number of SL-PRSs to be transmitted; a maximum transmit power; a length of the selection window; a per-slot probability of selecting one of the resources available during the selection window; a bandwidth for SL-PRS within the selection window; or a length of consecutive slots available for repetitions of SL-PRS.

In some aspects, a first subset of the plurality of selection windows comprise resources for transmitting an SL-PRS and a second subset of the plurality of selection windows comprise resources for receiving an SL-PRS.

In some aspects, at least one of the plurality of selection windows is divided into a plurality of different parts.

In some aspects, one of the plurality of different parts is configured random selection and another of the plurality of different parts is configured for selection based on full sensing or partial sensing.

In some aspects, one of the plurality of different parts is configured for SL-PRS transmission and another of the plurality of different parts is configured for SL-PRS reception.

In some aspects, performing SL positioning using one of the plurality of selection windows for SL positioning comprises identifying, during a sensing window, candidate resources within the RPP for transmitting or receiving SL-PRSs, determining that a SL-PRS should be transmitted or received, identifying a first selection window for SL positioning from among the plurality of selection windows for SL positioning, selecting, from among resources within the first selection window for SL positioning, one or more resources for transmitting or receiving an SL-PRS, and transmitting or receiving the SL-PRS on the selected resource.

In some aspects, performing SL positioning using one of the plurality of selection windows for SL positioning comprises identifying, during a sensing window, candidate resources within the RPP for transmitting or receiving SL-PRSs, determining that a SL-PRS should be transmitted or received, identifying a first selection window for SL positioning from among the plurality of selection windows for SL positioning, failing to select one or more resources for transmitting or receiving an SL-PRS from among resources within the first selection window for SL positioning a threshold number of times, identifying a second selection window for SL positioning from among the plurality of selection windows for SL positioning, selecting, from among resources within the second selection window for SL positioning, one or more resources for transmitting or receiving an SL-PRS, and transmitting or receiving the SL-PRS on the selected resource.

In some aspects, process 1500 includes at least one of notifying the configuration entity of the failure to select one or more resources for transmitting or receiving an SL-PRS from among resources within the first selection window for SL positioning the threshold number of times, or disqualifying the first selection window for SL positioning for use for a specified backoff time.

In some aspects, receiving the first configuration defining a plurality of selection windows for SL positioning comprises receiving a first configuration that defines a plurality of selection windows for SL positioning or SL data and a second configuration that identifies a subset of the plurality of selection windows as being reserved for SL positioning.

In some aspects, receiving the first configuration from the configuration entity comprises receiving the first configuration from an anchor UE.

Although FIG. 15 shows example blocks of process 1500, in some implementations, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a flowchart of an example process 1600 associated with multiple selection windows for a sidelink resource pool for positioning, according to aspects of the disclosure. In some implementations, one or more process blocks of FIG. 16 may be performed by a configuration entity (e.g., an anchor UE 104). In some implementations, one or more process blocks of FIG. 16 may be performed by another device or a group of devices separate from or including the configuration entity. Additionally, or alternatively, one or more process blocks of FIG. 16 may be performed by one or more components of an apparatus, such as a processor(s), memory, or transceiver(s), any or all of which may be means for performing the operations of process 1600.

As shown in FIG. 16, at block 1610, process 1600 may include identifying a UE. Means for performing the operation of block 1610 may include the processor(s), memory, or transceiver(s) of any of the apparatuses described herein. For example, the processor(s) 332 of the configuration entity may identify a UE based on the presence of a SL communication session with the UE.

As further shown in FIG. 16, at block 1620, process 1600 may include sending, to the UE, a first configuration, the first configuration defining a plurality of selection windows for SL positioning, each selection window defining a set of resources within a RPP for transmission or reception of at least one SL-PRS. Means for performing the operation of block 1620 may include the processor(s), memory, or transceiver(s) of any of the apparatuses described herein. For example, the configuration entity may send the first configuration to the UE using the transmitter(s) 314.

Process 1600 may include additional implementations, such as any single implementation or any combination of implementations described below and/or in connection with one or more other processes described elsewhere herein.

In some aspects, process 1600 includes receiving, from the UE, an indication that the UE failed to select one or more resources for transmitting or receiving an SL-PRS from among resources within the first selection window for SL positioning the threshold number of times, modifying the first configuration in response to the indication, and sending the modified first configuration to the UE.

In some aspects, modifying the first configuration in response to the indication comprises at least one of modifying a configuration of the first selection window, deleting the first selection window from the plurality of selection windows, or adding a new selection window to the plurality of selection windows.

In some aspects, the configuration entity comprises an anchor UE.

Although FIG. 16 shows example blocks of process 1600, in some implementations, process 1600 may include additional blocks, fewer blocks, different blocks, or differently arranged blocks than those depicted in FIG. 16. Additionally, or alternatively, two or more of the blocks of process 1600 may be performed in parallel.

As will be appreciated, a technical advantage of the techniques disclosed herein is that SL positioning can have the same benefits as SL data transmission-namely, that multiple selection windows provide flexibility and increase efficiency of SL positioning, e.g., by reducing latency of SL positioning and reducing the chance that a random selection by one device will collide with a sensing based selection by another device.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless positioning performed by a user equipment (UE), the method comprising: receiving, from a configuration entity, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS); and performing SL positioning using one of the plurality of selection windows for SL positioning.

Clause 2. The method of clause 1, wherein each of the plurality of selection windows defined by the first configuration is associated with at least one of the following parameters: a sensing type, comprising at least one of random selection, full sensing, or partial sensing, to be performed during the selection window; a priority; a minimum number of sub-channels; a maximum number of sub-channels; a maximum number of SL-PRSs to be transmitted; a maximum transmit power; a length of the selection window; a per-slot probability of selecting one of the resources available during the selection window; a bandwidth for SL-PRS within the selection window; or a length of consecutive slots available for repetitions of SL-PRS.

Clause 3. The method of any of clauses 1 to 2, wherein a first subset of the plurality of selection windows comprise resources for transmitting an SL-PRS and a second subset of the plurality of selection windows comprise resources for receiving an SL-PRS.

Clause 4. The method of any of clauses 1 to 3, wherein at least one of the plurality of selection windows is divided into a plurality of different parts.

Clause 5. The method of clause 4, wherein one of the plurality of different parts is configured random selection and another of the plurality of different parts is configured for selection based on full sensing or partial sensing.

Clause 6. The method of any of clauses 4 to 5, wherein one of the plurality of different parts is configured for SL-PRS transmission and another of the plurality of different parts is configured for SL-PRS reception.

Clause 7. The method of any of clauses 1 to 6, wherein performing SL positioning using one of the plurality of selection windows for SL positioning comprises: identifying, during a sensing window, candidate resources within the RPP for transmitting or receiving SL-PRSs; determining that a SL-PRS should be transmitted or received; identifying a first selection window for SL positioning from among the plurality of selection windows for SL positioning; selecting, from among resources within the first selection window for SL positioning, one or more resources for transmitting or receiving an SL-PRS; and transmitting or receiving the SL-PRS on the selected resource.

Clause 8. The method of clause 7, wherein performing SL positioning using one of the plurality of selection windows for SL positioning comprises: identifying, during a sensing window, candidate resources within the RPP for transmitting or receiving SL-PRSs; determining that a SL-PRS should be transmitted or received; identifying a first selection window for SL positioning from among the plurality of selection windows for SL positioning; failing to select one or more resources for transmitting or receiving an SL-PRS from among resources within the first selection window for SL positioning a threshold number of times; identifying a second selection window for SL positioning from among the plurality of selection windows for SL positioning; selecting, from among resources within the second selection window for SL positioning, one or more resources for transmitting or receiving an SL-PRS; and transmitting or receiving the SL-PRS on the selected resource.

Clause 9. The method of clause 8, further comprising at least one of: notifying the configuration entity of the failure to select one or more resources for transmitting or receiving an SL-PRS from among resources within the first selection window for SL positioning the threshold number of times; or disqualifying the first selection window for SL positioning for use for a specified backoff time.

Clause 10. The method of any of clauses 1 to 9, wherein receiving the first configuration defining a plurality of selection windows for SL positioning comprises receiving a first configuration that defines a plurality of selection windows for SL positioning or SL data and a second configuration that identifies a subset of the plurality of selection windows as being reserved for SL positioning.

Clause 11. The method of any of clauses 1 to 10, wherein receiving the first configuration from the configuration entity comprises receiving the first configuration from an anchor UE.

Clause 12. A method of wireless positioning performed by a configuration entity, the method comprising: identifying a user equipment (UE); and sending, to the UE, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS).

Clause 13. The method of clause 12, further comprising: receiving, from the UE, an indication that the UE failed to select one or more resources for transmitting or receiving an SL-PRS from among resources within the first selection window for SL positioning the threshold number of times; modifying the first configuration in response to the indication; and sending the modified first configuration to the UE.

Clause 14. The method of clause 13, wherein modifying the first configuration in response to the indication comprises at least one of: modifying a configuration of the first selection window; deleting the first selection window from the plurality of selection windows; or adding a new selection window to the plurality of selection windows.

Clause 15. The method of any of clauses 12 to 14, wherein the configuration entity comprises an anchor UE.

Clause 16. A user equipment (UE), comprising: a memory; at least one transceiver; and at least one processor communicatively coupled to the memory and the at least one transceiver, the at least one processor configured to: receive, from a configuration entity via the at least one transceiver, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS); and perform, using the at least one transceiver, SL positioning using one of the plurality of selection windows for SL positioning.

Clause 17. The UE of clause 16, wherein each of the plurality of selection windows defined by the first configuration is associated with at least one of the following parameters: a sensing type, comprising at least one of random selection, full sensing, or partial sensing, to be performed during the selection window; a priority; a minimum number of sub-channels; a maximum number of sub-channels; a maximum number of SL-PRSs to be transmitted; a maximum transmit power; a length of the selection window; a per-slot probability of selecting one of the resources available during the selection window; a bandwidth for SL-PRS within the selection window; or a length of consecutive slots available for repetitions of SL-PRS.

Clause 18. The UE of any of clauses 16 to 17, wherein a first subset of the plurality of selection windows comprise resources for transmitting an SL-PRS and a second subset of the plurality of selection windows comprise resources for receiving an SL-PRS.

Clause 19. The UE of any of clauses 16 to 18, wherein at least one of the plurality of selection windows is divided into a plurality of different parts.

Clause 20. The UE of clause 19, wherein one of the plurality of different parts is configured random selection and another of the plurality of different parts is configured for selection based on full sensing or partial sensing.

Clause 21. The UE of any of clauses 19 to 20, wherein one of the plurality of different parts is configured for SL-PRS transmission and another of the plurality of different parts is configured for SL-PRS reception.

Clause 22. The UE of any of clauses 16 to 21, wherein, to perform SL positioning using one of the plurality of selection windows for SL positioning, the at least one processor is configured to: identify, during a sensing window, candidate resources within the RPP for transmitting or receiving SL-PRSs; determine that a SL-PRS should be transmitted or received; identify a first selection window for SL positioning from among the plurality of selection windows for SL positioning; select, from among resources within the first selection window for SL positioning, one or more resources for transmitting or receiving an SL-PRS; and transmit or receive, via the at least one transceiver, the SL-PRS on the selected resource.

Clause 23. The UE of clause 22, wherein, to perform SL positioning using one of the plurality of selection windows for SL positioning, the at least one processor is configured to: identify, during a sensing window, candidate resources within the RPP for transmitting or receiving SL-PRSs; determine that a SL-PRS should be transmitted or received; identify a first selection window for SL positioning from among the plurality of selection windows for SL positioning; fail to select one or more resources for transmitting or receiving an SL-PRS from among resources within the first selection window for SL positioning a threshold number of times; identify a second selection window for SL positioning from among the plurality of selection windows for SL positioning; select, from among resources within the second selection window for SL positioning, one or more resources for transmitting or receiving an SL-PRS; and transmit or receive, via the at least one transceiver, the SL-PRS on the selected resource.

Clause 24. The UE of clause 23, wherein the at least one processor is further configured to at least one of: notify the configuration entity of the failure to select one or more resources for transmitting or receiving an SL-PRS from among resources within the first selection window for SL positioning the threshold number of times; or disqualify the first selection window for SL positioning for use for a specified backoff time.

Clause 25. The UE of any of clauses 16 to 24, wherein, to receive the first configuration defining a plurality of selection windows for SL positioning, the at least one processor is configured to receive a first configuration that defines a plurality of selection windows for SL positioning or SL data and a second configuration that identifies a subset of the plurality of selection windows as being reserved for SL positioning.

Clause 26. The UE of any of clauses 16 to 25, wherein, to receive the first configuration from the configuration entity, the at least one processor is configured to receive the first configuration from an anchor UE.

Clause 27. A configuration entity, comprising: a memory; at least one transceiver; and at least one processor communicatively coupled to the memory and the at least one transceiver, the at least one processor configured to: identify a user equipment (UE); and send, to the UE via the at least one transceiver, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS).

Clause 28. The configuration entity of clause 27, wherein the at least one processor is further configured to: receive, from the UE via the at least one transceiver, an indication that the UE failed to select one or more resources for transmitting or receiving an SL-PRS from among resources within the first selection window for SL positioning the threshold number of times; modify the first configuration in response to the indication; and send, to the UE via the at least one transceiver, the modified first configuration.

Clause 29. The configuration entity of clause 28, wherein, to modify the first configuration in response to the indication, the at least one processor is configured to: modify a configuration of the first selection window; delete the first selection window from the plurality of selection windows; or add a new selection window to the plurality of selection windows.

Clause 30. The configuration entity of any of clauses 27 to 29, wherein the configuration entity comprises an anchor UE.

Clause 31. An apparatus comprising a memory, a transceiver, and a processor communicatively coupled to the memory and the transceiver, the memory, the transceiver, and the processor configured to perform a method according to any of clauses 1 to 15.

Clause 32. An apparatus comprising means for performing a method according to any of clauses 1 to 15.

Clause 33. A non-transitory computer-readable medium storing computer-executable instructions, the computer-executable comprising at least one instruction for causing a computer or processor to perform a method according to any of clauses 1 to 15.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless positioning performed by a user equipment (UE), the method comprising:
receiving, from a configuration entity, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS); and
performing SL positioning using one of the plurality of selection windows for SL positioning.

2. The method of claim 1, wherein each of the plurality of selection windows defined by the first configuration is associated with at least one of:
a sensing type, comprising at least one of random selection, full sensing, or partial sensing, to be performed during the respective selection window;
a priority;
a minimum number of sub-channels;
a maximum number of sub-channels;
a maximum number of SL-PRSs to be transmitted;
a maximum transmit power;
a length of the respective selection window;
a per-slot probability of selecting one of the resources available during the respective selection window;
a bandwidth for SL-PRS within the respective selection window; or
a length of consecutive slots available for repetitions of SL-PRS.

3. The method of claim 1, wherein a first subset of the plurality of selection windows comprise resources for transmitting an SL-PRS and a second subset of the plurality of selection windows comprise resources for receiving an SL-PRS.

4. The method of claim 1, wherein at least one of the plurality of selection windows is divided into a plurality of different parts.

5. The method of claim 4, wherein one of the plurality of different parts is configured random selection and another of the plurality of different parts is configured for selection based on full sensing or partial sensing.

6. The method of claim 4, wherein one of the plurality of different parts is configured for SL-PRS transmission and another of the plurality of different parts is configured for SL-PRS reception.

7. The method of claim 1, wherein performing SL positioning using one of the plurality of selection windows for SL positioning comprises:
identifying, during a sensing window, candidate resources within the RPP for transmitting or receiving SL-PRSs;
determining that a SL-PRS should be transmitted or received;
identifying a first selection window for SL positioning from among the plurality of selection windows for SL positioning;
selecting, from among the resources within the first selection window for SL positioning, one or more resources for transmitting or receiving an SL-PRS; and
transmitting or receiving the SL-PRS on the one or more resources.

8. The method of claim 7, wherein performing SL positioning using one of the plurality of selection windows for SL positioning comprises:
identifying, during a sensing window, candidate resources within the RPP for transmitting or receiving SL-PRSs;
determining that a SL-PRS should be transmitted or received;
identifying a first selection window for SL positioning from among the plurality of selection windows for SL positioning;
failing to select one or more resources for transmitting or receiving the SL-PRS from among the resources within the first selection window for SL positioning a threshold number of times;
identifying a second selection window for SL positioning from among the plurality of selection windows for SL positioning;
selecting, from among the resources within the second selection window for SL positioning, one or more resources for transmitting or receiving the SL-PRS; and
transmitting or receiving the SL-PRS on the one or more resources.

9. The method of claim 8, further comprising at least one of:
notifying the configuration entity of the failing to select one or more resources for transmitting or receiving the SL-PRS from among the resources within the first selection window for SL positioning the threshold number of times; or
disqualifying the first selection window for SL positioning for use for a specified backoff time.

10. The method of claim 1, wherein receiving the first configuration defining a plurality of selection windows for SL positioning comprises receiving a first configuration that defines a plurality of selection windows for SL positioning or SL data and a second configuration that identifies a subset of the plurality of selection windows as being reserved for SL positioning.

11. The method of claim 1, wherein receiving the first configuration from the configuration entity comprises receiving the first configuration from an anchor UE.

12. A method of wireless positioning performed by a configuration entity, the method comprising:
identifying a user equipment (UE); and
sending, to the UE, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS).

13. The method of claim 12, further comprising:
receiving, from the UE, an indication that the UE failed to select one or more resources for transmitting or receiving an SL-PRS from among the resources within a first selection window for SL positioning from the plurality of selection windows for SL positioning a threshold number of times;
modifying the first configuration in response to the indication; and
sending the modified first configuration to the UE.

14. The method of claim 13, wherein modifying the first configuration in response to the indication comprises at least one of:
modifying a configuration of the first selection window;
deleting the first selection window from the plurality of selection windows; or
adding a new selection window to the plurality of selection windows.

15. The method of claim 12, wherein the configuration entity comprises an anchor UE.

16. A user equipment (UE), comprising:
a memory;
at least one transceiver; and
at least one processor communicatively coupled to the memory and the at least one transceiver, the at least one processor configured to:
receive, from a configuration entity via the at least one transceiver, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS); and
perform, using the at least one transceiver, SL positioning using one of the plurality of selection windows for SL positioning.

17. The UE of claim 16, wherein each of the plurality of selection windows defined by the first configuration is associated with at least one of:
a sensing type, comprising at least one of random selection, full sensing, or partial sensing, to be performed during the respective selection window;
a priority;
a minimum number of sub-channels;
a maximum number of sub-channels;
a maximum number of SL-PRSs to be transmitted;
a maximum transmit power;
a length of the respective selection window;
a per-slot probability of selecting one of the resources available during the respective selection window;
a bandwidth for SL-PRS within the respective selection window; or
a length of consecutive slots available for repetitions of SL-PRS.

18. The UE of claim 16, wherein a first subset of the plurality of selection windows comprise resources for transmitting an SL-PRS and a second subset of the plurality of selection windows comprise resources for receiving an SL-PRS.

19. The UE of claim 16, wherein at least one of the plurality of selection windows is divided into a plurality of different parts.

20. The UE of claim 19, wherein one of the plurality of different parts is configured random selection and another of the plurality of different parts is configured for selection based on full sensing or partial sensing.

21. The UE of claim 19, wherein one of the plurality of different parts is configured for SL-PRS transmission and another of the plurality of different parts is configured for SL-PRS reception.

22. The UE of claim 16, wherein, to perform SL positioning using one of the plurality of selection windows for SL positioning, the at least one processor is configured to:
identify, during a sensing window, candidate resources within the RPP for transmitting or receiving SL-PRSs;
determine that a SL-PRS should be transmitted or received;
identify a first selection window for SL positioning from among the plurality of selection windows for SL positioning;
select, from among the resources within the first selection window for SL positioning, one or more resources for transmitting or receiving an SL-PRS; and
transmit or receive, via the at least one transceiver, the SL-PRS on the one or more resources.

23. The UE of claim 22, wherein, to perform SL positioning using one of the plurality of selection windows for SL positioning, the at least one processor is configured to:
identify, during a sensing window, candidate resources within the RPP for transmitting or receiving SL-PRSs;
determine that a SL-PRS should be transmitted or received;
identify a first selection window for SL positioning from among the plurality of selection windows for SL positioning;
fail to select one or more resources for transmitting or receiving the SL-PRS from among the resources within the first selection window for SL positioning a threshold number of times;
identify a second selection window for SL positioning from among the plurality of selection windows for SL positioning;
select, from among the resources within the second selection window for SL positioning, one or more resources for transmitting or receiving the SL-PRS; and
transmit or receive, via the at least one transceiver, the SL-PRS on the one or more resources.

24. The UE of claim 23, wherein the at least one processor is further configured to at least one of:
notify the configuration entity of the failing to select one or more resources for transmitting or receiving the SL-PRS from among the resources within the first selection window for SL positioning the threshold number of times; or
disqualify the first selection window for SL positioning for use for a specified backoff time.

25. The UE of claim 16, wherein, to receive the first configuration defining a plurality of selection windows for SL positioning, the at least one processor is configured to receive a first configuration that defines a plurality of selection windows for SL positioning or SL data and a second configuration that identifies a subset of the plurality of selection windows as being reserved for SL positioning.

26. The UE of claim 16, wherein, to receive the first configuration from the configuration entity, the at least one processor is configured to receive the first configuration from an anchor UE.

27. A configuration entity, comprising:
a memory;
at least one transceiver; and
at least one processor communicatively coupled to the memory and the at least one transceiver, the at least one processor configured to:
identify a user equipment (UE); and
send, to the UE via the at least one transceiver, a first configuration, the first configuration defining a plurality of selection windows for sidelink (SL) positioning, each selection window defining a set of resources within a resource pool for positioning (RPP) for transmission or reception of at least one sidelink positioning reference signal (SL-PRS).

28. The configuration entity of claim 27, wherein the at least one processor is further configured to:
receive, from the UE via the at least one transceiver, an indication that the UE failed to select one or more resources for transmitting or receiving an SL-PRS from among the resources within a first selection window for SL positioning from the plurality of selection windows for SL positioning a threshold number of times;
modify the first configuration in response to the indication; and
send, to the UE via the at least one transceiver, the modified first configuration.

29. The configuration entity of claim 28, wherein, to modify the first configuration in response to the indication, the at least one processor is configured to:
modify a configuration of the first selection window;
delete the first selection window from the plurality of selection windows; or
add a new selection window to the plurality of selection windows.

30. The configuration entity of claim 27, wherein the configuration entity comprises an anchor UE.
